(19) United States
(12) Patent Application Publication
(10) Pub. No.: US 2002/0174111 A1
(43) Pub. Date: Nov. 21, 2002

(54) System and method for managing resources stored in a relational database system

(76) Inventor: Panagiotis Kougiouris, San Jose, CA (US)

Correspondence Address: Jeffrey C. Hood, Conley, Rose, & Tayon, P.C., P.O. Box 398, Austin, TX, 78767, US

(21) Appl. No.: 09/862,349

(22) Filed: May 21, 2001

(51) Int. Cl. G06F 7/00

(52) U.S. Cl. 707/3

(57) ABSTRACT

An improved method and system for analyzing a database for managing resources stored in a relational database system. In one embodiment, the method involves executing a first process, storing results (e.g., work items) of the first process, and executing multiple versions of a second process. The first process may comprise multiple processes (e.g., producer processes). The first process may create multiple work items which may be stored. Each version of the second process may retrieve either a unique work item for processing or no work item. The retrieval may be facilitated by use of a randomly generated number compared to a subset of a field of the multiple work items (e.g., a seconds portion of a timestamp field). The second process may comprise multiple consumer processes. The versions of the second process that retrieve no work item may be re-executed repeatedly, until a unique work item for processing is retrieved.

### BACKGROUND OF THE INVENTION

1. Field of the Invention

The present invention relates to computer software, and more particularly to managing resources stored in a relational database system.

2. Description of the Related Art

Relational database management systems (RDBMS) are in widespread commercial use in today's economy, (e.g., managing transactions on the Internet). In a large-scale RDBMS, daily transaction rates may number in the thousands. Current methods of processing new transactions may result in contention problems, as thousands of rows might be available to be worked on, and multiple processes running in parallel (i.e., transactions) may select the same row for processing.

In the case where more than one multiple process running in parallel selects the same row for processing, at most one, and perhaps none, of the parallel processes may succeed in completing a transaction. In one RDBMS implementation, only one of those multiple processes running in parallel may succeed at updating the selected row and all the other processes may abort to avoid deadlock. As used herein, a “deadlock” may occur when a first user holds a lock on a resource needed by a second user, while the second user holds a lock on a resource needed by the first user. Thus, the processing performed by the processes that abort is wasted effort. In other RDBMS implementations, all the parallel transactions may abort, resulting in a total waste of effort. Additionally, transactions which are aborted will need to be re-executed. On second and possibly subsequent iterations or executions of the same transaction, additional abortions to avoid deadlock may occur, as collisions with other transactions selecting the same row for processing continue.

As used herein, a “producer process” may produce work items and store the work items in a database (e.g., inserting a row in a first relational database table). As used herein, a “consumer process” may consume work items from the database (e.g., updating a row in the first relational database table to indicate it is being worked on).

As shown in the example SQL Server Transact-SQL code of FIG. 4, a prior art method for managing resources stored in a relational database system may generate multiple consumer processes that select the same row for processing, thus causing a deadlock, and wasted effort.

In particular, the combination of line 428 and line 430 typically results in more than one consumer process selecting a single, particular work item, even though thousands of work items might be available to be worked on, thus causing all but one, or perhaps all (i.e., depending on the implementation) of the consumer processes aborting their transactions (i.e., at line 438) to avoid deadlock, thus resulting in a large amount of wasted effort.

Aborting transactions in these ways is very expensive because work has to be redone. It is desirable to avoid aborting transactions to minimize cost and minimize rework. For at least the foregoing reasons, there is a need for an improved system and method for managing resources stored in a relational database system such that aborting of transactions due to deadlocks is minimized.

### SUMMARY OF THE INVENTION

The present invention provides various embodiments of an improved method and system for managing resources stored in a relational database system. In one embodiment, the method involves executing a first process, storing results (e.g., work items) of the first process in the relational database system, and executing multiple versions of a second process.

The first process may comprise multiple parallel versions of the first process and/or multiple processes. The function of the first process may be to create one or more producer processes. The producer processes may create one or more work items. The one or more work items may be stored in the relational database system (e.g., in a first relational database table). In one embodiment, the first relational database table may comprise the following columns: PrimaryKey, LastUpdated, and State, among others.

The PrimaryKey column (also referred to as a PrimaryKey field) may hold a unique value for each database record or row in the first relational database table. The LastUpdated column may represent a timestamp of the last update to the row or record. The State column may be a one-character field, with values ‘n’ for new and ‘w’ for work in progress, among others (e.g., ‘c’ for complete).

Each version of the multiple versions of the second process may retrieve either a unique work item for processing or no work item. The retrieval of either the unique work item for processing or no work item may be facilitated by each version of the multiple versions of the second process using a randomly generated number. The randomly generated number may be compared to a subset of a field of the multiple work items. The subset of the field of the multiple work items may be a seconds portion of a timestamp field. The second process may comprise one or more consumer processes.

The versions of the second process that retrieve no work item may be re-executed repeatedly, until such time as a unique work item for processing is retrieved.

### BRIEF DESCRIPTION OF THE DRAWINGS

A better understanding of the present invention can be obtained when the following detailed description of various embodiments is considered in conjunction with the following drawings, in which:

FIG. 1 is a network diagram of a wide area network that is suitable for implementing various embodiments;

FIG. 2 is an illustration of a typical computer system that is suitable for implementing various embodiments;

FIG. 3 is a flowchart illustrating a process to manage resources stored in a relational database system according to one embodiment;

FIG. 4 is example SQL Server Transact-SQL code illustrating a prior art method for managing resources stored in a relational database system; and

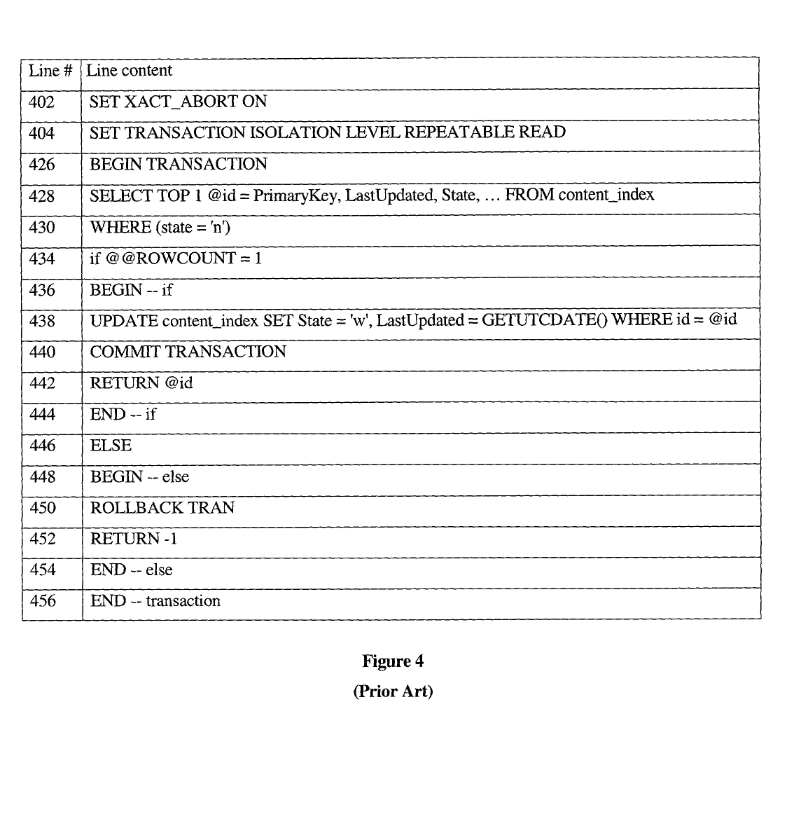

FIG. 5 is example SQL Server Transact-SQL code illustrating one embodiment of the present invention for managing resources stored in a relational database system.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents, and alternatives falling within the spirit and scope of the present invention as defined by the appended claims.

### DETAILED DESCRIPTION OF SEVERAL EMBODIMENTS

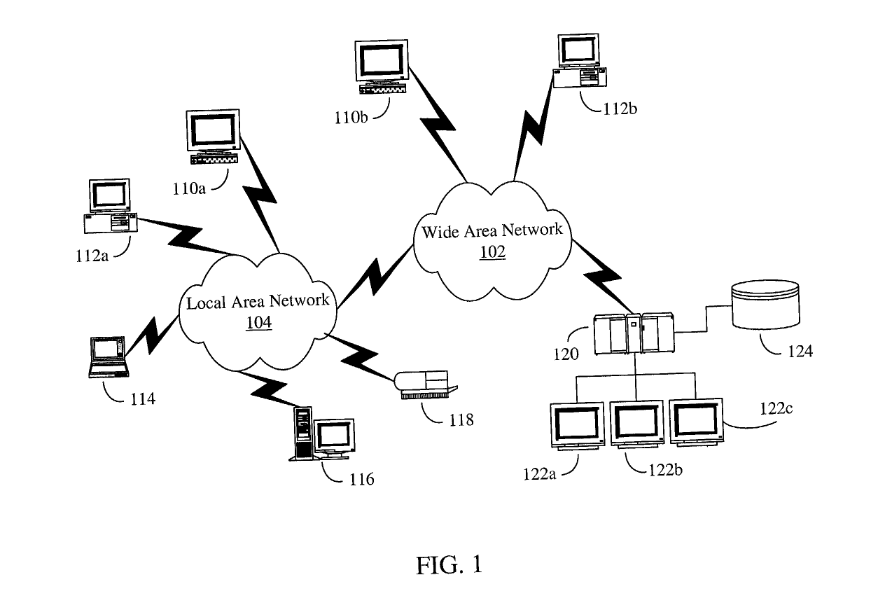

FIG. 1: Wide Area Network

FIG. 1 illustrates a wide area network (WAN) that is suitable for implementing various embodiments of a system and method for managing resources stored in a relational database system. A WAN 102 is a network that spans a relatively large geographical area. The Internet is an example of a WAN 102. A WAN 102 typically includes a plurality of computer systems which are interconnected through one or more networks. Although one particular configuration is shown in FIG. 1, the WAN 102 may include a variety of heterogeneous computer systems and networks which are interconnected in a variety of ways and which run a variety of software applications.

One or more local area networks (LANs) 104 may be coupled to the WAN 102. A LAN 104 is a network that spans a relatively small area. Typically, a LAN 104 is confined to a single building or group of buildings. Each node (i.e., individual computer system or device) on a LAN 104 preferably has its own CPU with which it executes programs, and each node is also able to access data and devices anywhere on the LAN 104. The LAN 104 thus allows many users to share devices (e.g., printers) as well as data stored on file servers. The LAN 104 may be characterized by any of a variety of types of topology (i.e., the geometric arrangement of devices on the network), of protocols (i.e., the rules and encoding specifications for sending data, and whether the network uses a peer-to-peer or client/server architecture), and of media (e.g., twisted-pair wire, coaxial cables, fiber optic cables, radio waves).

Each LAN 104 includes a plurality of interconnected computer systems and optionally one or more other devices: for example, one or more workstations 1 10a, one or more personal computers 112a, one or more laptop or notebook computer systems 114, one or more server computer systems 116, and one or more network printers 118. As illustrated in FIG. 1, an example LAN 104 may include one of each of computer systems 110a, 112a, 114, and 116, and one printer 118. The LAN 104 may be coupled to other computer systems and/or other devices and/or other LANs 104 through the WAN 102.

One or more mainframe computer systems 120 may be coupled to the WAN 102. As shown, the mainframe 120 may be coupled to a storage device or file server 124 and mainframe terminals 122a, 122b, and 122c. The mainframe terminals 122a, 122b, and 122c may access data stored in the storage device or file server 124 coupled to or included in the mainframe computer system 120.

The WAN 102 may also include computer systems which are connected to the WAN 102 individually and not through a LAN 104: as illustrated, for purposes of example, a workstation 110b and a personal computer 112b. For example, the WAN 102 may include computer systems which are geographically remote and connected to each other through the Internet. Any of the computer systems connected to the WAN 102 (e.g., 110a, 110b, 112a, 112b, 114, 116, 120) may be operable to execute computer programs to implement managing resources stored in a relational database system as described herein.

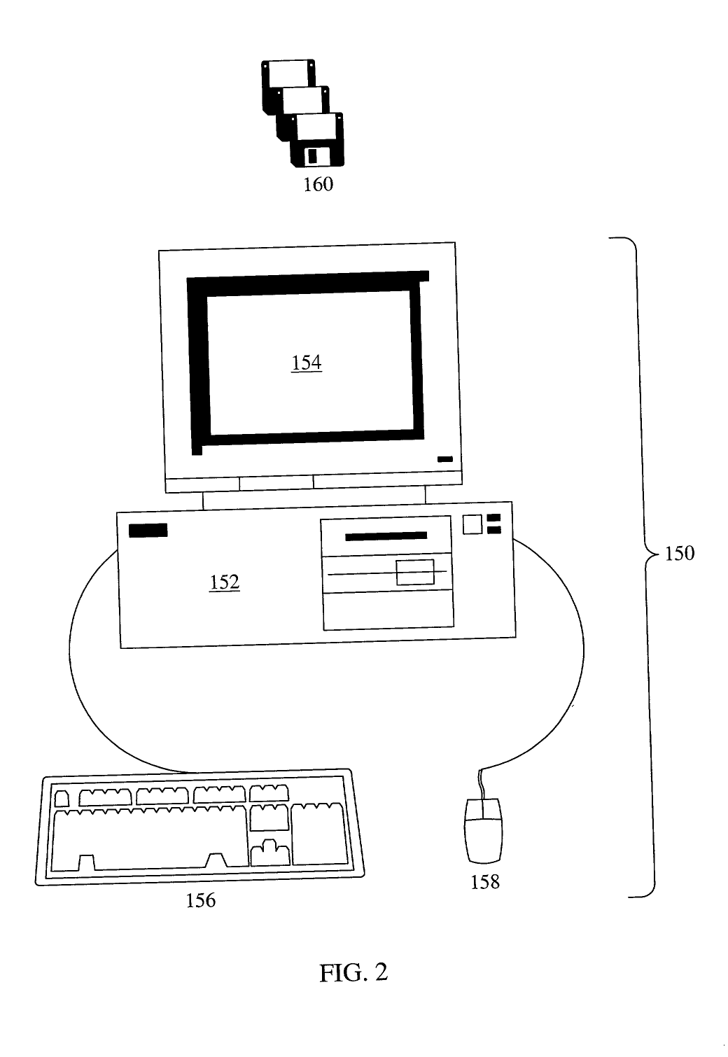

FIG. 2: Typical Computer System

FIG. 2 illustrates a typical computer system 150 that is suitable for implementing various embodiments of a system and method for managing resources stored in a relational database system. Each computer system 150 typically includes components such as a CPU 152 with an associated memory medium such as floppy disks 160. The memory medium may store program instructions for computer programs, wherein the program instructions are executable by the CPU 152. The computer system 150 may further include a display device such as a monitor 154, an alphanumeric input device such as a keyboard 156, and a directional input device such as a mouse 158. The computer system 150 may be operable to execute the computer programs to implement managing resources stored in a relational database system as described herein.

The computer system 150 preferably includes a memory medium on which computer programs according to various embodiments may be stored. The term “memory medium” is intended to include an installation medium, e.g., a CD-ROM, or floppy disks 160, a computer system memory such as DRAM, SRAM, EDO RAM, Rambus RAM, etc., or a non-volatile memory such as a magnetic media, e.g., a hard drive, or optical storage. The memory medium may include other types of memory as well, or combinations thereof. In addition, the memory medium may be located in a first computer in which the programs are executed, or may be located in a second different computer which connects to the first computer over a network. In the latter instance, the second computer provides the program instructions to the first computer for execution. Also, the computer system 150 may take various forms, including a personal computer system, mainframe computer system, workstation, network appliance, Internet appliance, personal digital assistant (PDA), television system or other device. In general, the term “computer system” may be broadly defined to encompass any device having a processor which executes instructions from a memory medium.

The memory medium preferably stores a software program or programs for managing resources stored in a relational database system as described herein. The software program(s) may be implemented in any of various ways, including procedure-based techniques, component-based techniques, and/or object-oriented techniques, among others. For example, the software program may be implemented using ActiveX controls, C++ objects, JavaBeans, Microsoft Foundation Classes (MFC), browser-based applications (e.g., Java applets), traditional programs, or other technologies or methodologies, as desired. A CPU, such as the host CPU 152, executing code and data from the memory medium includes a means for creating and executing the software program or programs according to the methods and/or block diagrams described below.

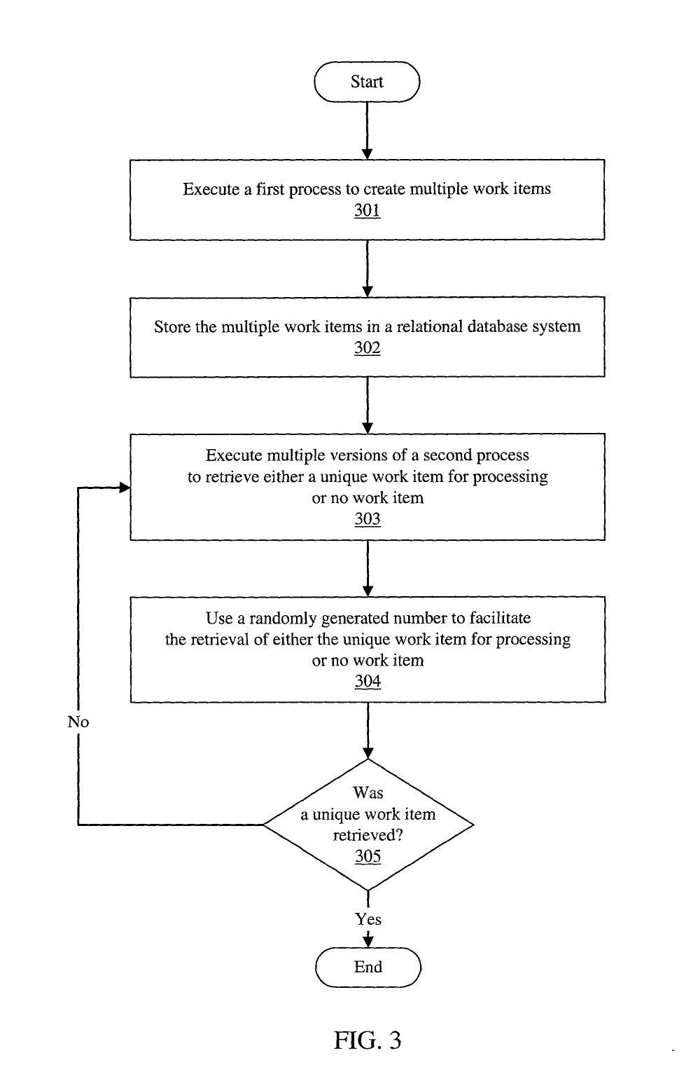

FIG. 3: Managing Resources Stored in a Relational Database System

As shown in step 301, a first process may be executed. The first process may create multiple work items (e.g., rows in a database). The first process may include multiple parallel versions of the first process. The first process may include multiple processes. In one embodiment, the first process may include one or more producer processes.

Although the creation and storage of the multiple work items is shown in series, the multiple parallel versions of the first process may create and store the multiple work items in parallel, (i.e., one version of the first process need not complete storing its work item prior to another version of the first process creating and storing its work item).

In step 302, the multiple work items may be stored in a relational database system (e.g., in a first relational database table). In one embodiment, the first relational database table may comprise the following columns: PrimaryKey, LastUpdated, and State, among others.

The PrimaryKey column (also referred to as a PrimaryKey field) may hold a unique value for each database record or row in the first relational database table. The PrimaryKey column may be used to sort data in the first relational database table. Additional columns may exist in the first relational database table containing keys, but these additional keys would be secondary keys, as there can be only one primary key per relational database table. One use for secondary keys is to allow sorting of database records in different ways. A foreign key may be considered a special case of a secondary key field. A foreign key may identify database records in a second relational database table, within the same database as the first relational database table.

The LastUpdated column may represent a timestamp of the last update to the row or record. The State column may be a one-character field, with values ‘n’ for new and ‘w’ for work in progress. Additional values may also be used for the State column to indicate further progress of the database record (e.g., ‘c’ for complete).

In one embodiment, a producer process may produce a work item and store the work item in the database by inserting a row in the first relational database table. For example, the producer process may store the following values: PrimaryKey=“1”, LastUpdated=“03-26-2001 16:45:28”, and State=“n”.

In step 303, multiple versions of a second process may be executed. Each version of the multiple versions of the second process may retrieve either a unique work item for processing or no work item. The second process may include one or more consumer processes.

Although the execution of the multiple versions of the second process is shown as occurring after the creation and storage of the multiple work items (i.e., in series), the multiple versions of the second process may be executed in parallel with the creation and storage of the multiple work items. Thus, work items may continuously be created and stored by versions of the first process, at the same time that versions of the second process are retrieving work items that have previously been stored.

In step 304, the retrieval of either the unique work item for processing or no work item may be facilitated by each version of the multiple versions of the second process using a randomly generated number. The randomly generated number may be compared to a subset of a field of the multiple work items. The subset of the field of the multiple work items may be a seconds portion of a timestamp field.

In one embodiment, a consumer process may select a work item with State=“n” and subsequently consume the work item originally stored by the producer process, by updating the State column for the row in the first relational database table to indicate it is being worked on (i.e., State=“w”). Thus, other consumer processes would not select and/or update the row represented by PrimaryKey=“1”, as the State column for that row would indicate that it is already being worked on by some other consumer process.

Step 305 is a decision step. If a unique work item was retrieved, processing may complete. However, if no work item was found, processing may loop back to step 303, to re-execute a version of the second process, to search for a unique work item.

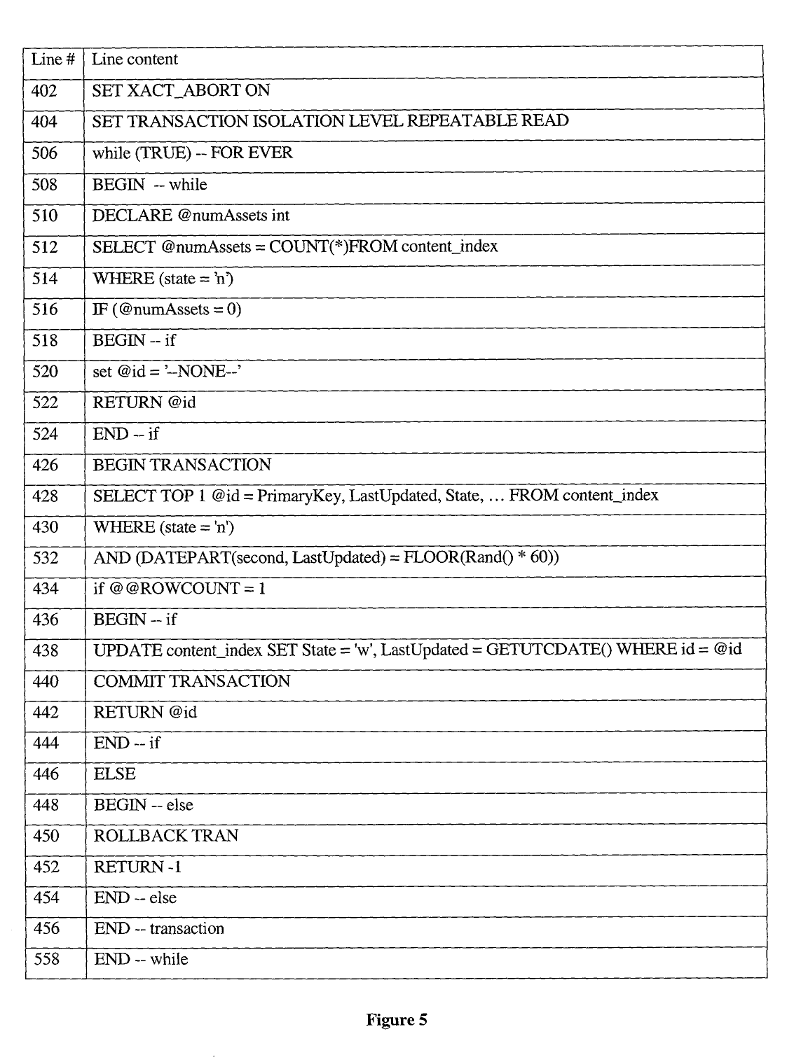

FIG. 5: Example SQL Server Transact-SQL Code

In one embodiment of the present invention, random numbers may be used to increase the likelihood that multiple parallel consumer processes select different (i.e., unique) available rows (i.e., rows with State=“n”). As shown in the code example of FIG. 5, a subset of a field (i.e., the seconds in the timestamp) may be used in the WHERE clause of the SELECT statement (i.e., line 532). If the seconds portion of the timestamp matches a randomly generated number (e.g., “FLOOR(Rand( )*60)), then that row may be selected by the consumer process. In one embodiment, the code example of FIG. 5 may be implemented as a stored procedure.

Since the SELECT statement (i.e., lines 428, 430, and 532) may return no rows or work items when rows do exist, the SELECT statement may be placed inside a WHIE loop (i.e., line 506). Additionally, line 512 shows a COUNT(*), one reason for such a COUNT may be to make sure that at least one row exists.

It is noted that the likelihood of the SELECT statement returning no rows or work items when rows do exist increases as the number of available rows decreases. Thus, one embodiment of the present invention is well suited to situations where a large number of available work items are in the database, awaiting selection by a consumer process.

As shown in line 532, an additional clause may be added to the WHERE statement of line 430 (i.e., “AND (DATEPART(second, LastUpdated)=FLOOR(Rand( )* 60))”). In one embodiment, both the DATEPART sub-clause and the FLOOR sub-clause, as shown, may return an integer between 0 and 59. For example, if the “LastUpdated” field contains the value “03-26-2001 16:45:28”, the DATEPART sub-clause shown in line 532 would return the seconds value of the “LastUpdated” field (i.e., 28).

If no work item or row is selected via the combination of line 428, line 430, and line 532, then re-executing a SELECT statement is much less costly than aborting a database transaction. Consider the following parameters: (C): number of consumer processes; (R): number of rows or work items in the database; (N): possible random number choices (i.e., this value depends on the method used to generate the random number; (W1): wasted work when a transaction aborts; (W2): wasted work when a consumer process finds no work item when there are work items available to be selected. In the case where: W1 is much greater than W2, R is much greater than N, and C is greater than N, it can be shown that aborting a database transaction is much more expensive than re-executing a SELECT statement.

Although the system and method of the present invention have been described in connection with several embodiments, the invention is not intended to be limited to the specific forms set forth herein, but on the contrary, it is intended to cover such alternatives, modifications, and equivalents as can be reasonably included within the spirit and scope of the invention as defined by the appended claims.

What is claimed is:

1. A method for managing resources stored in a relational database system, the method comprising:
executing a first process wherein the first process creates multiple work items;
storing the multiple work items in the relational database system;
executing multiple versions of a second process wherein each version of the multiple versions of the second process retrieves either a unique work item for processing or no work item;
wherein the retrieval of either the unique work item for processing or no work item is facilitated by each version of the multiple versions of the second process using a randomly generated number.

2. The method of claim 1,
wherein the randomly generated number is compared to a subset of a field of the multiple work items.

3. The method of claim 2,
wherein the subset of the field of the multiple work items is a seconds portion of a timestamp field.

4. The method of claim 1,
wherein the first process comprises multiple parallel versions of the first process.

5. The method of claim 1,
wherein the first process comprises multiple processes.

6. The method of claim 1,
wherein the first process comprises one or more producer processes.

7. The method of claim 1,
wherein the second process comprises one or more consumer processes.

8. The method of claim 1, further comprising:
re-executing the versions of the second process that retrieved no work item.

9. A system for managing resources stored in a relational database system, the system comprising:
a network;
a CPU coupled to the network;
a system memory coupled to the CPU, wherein the system memory stores one or more computer programs executable by the CPU;
wherein the computer programs are executable to:
execute a first process wherein the first process creates multiple work items;
store the multiple work items in the relational database system;
execute multiple versions of a second process wherein each version of the multiple versions of the second process retrieves either a unique work item for processing or no work item;
wherein the retrieval of either the unique work item for processing or no work item is facilitated by each version of the multiple versions of the second process using a randomly generated number.

10. The system of claim 9,
wherein the randomly generated number is compared to a subset of a field of the multiple work items.

11. The system of claim 10,
wherein the subset of the field of the multiple work items is a seconds portion of a timestamp field.

12. The system of claim 9,
wherein the first process comprises multiple parallel versions of the first process.

13. The system of claim 9,
wherein the first process comprises multiple processes.

14. The system of claim 9,
wherein the first process comprises one or more producer processes.

15. The system of claim 9,
wherein the second process comprises one or more consumer processes.

16. The system of claim 9, wherein the computer programs are further executable to:
re-execute the versions of the second process that retrieved no work item.

17. A carrier medium which stores program instructions for managing resources stored in a relational database system, wherein the program instructions are executable to implement:
executing a first process wherein the first process creates multiple work items;
storing the multiple work items in the relational database system;
executing multiple versions of a second process wherein each version of the multiple versions of the second process retrieves either a unique work item for processing or no work item;
wherein the retrieval of either the unique work item for processing or no work item is facilitated by each version of the multiple versions of the second process using a randomly generated number.

18. The carrier medium of claim 17,
wherein the randomly generated number is compared to a subset of a field of the multiple work items.

19. The carrier medium of claim 18,
wherein the subset of the field of the multiple work items is a seconds portion of a timestamp field.

20. The carrier medium of claim 17,
wherein the first process comprises multiple parallel versions of the first process.

21. The carrier medium of claim 17,
wherein the first process comprises multiple processes.

22. The carrier medium of claim 17,
wherein the first process comprises one or more producer processes.

23. The carrier medium of claim 17,
wherein the second process comprises one or more consumer processes.

24. The carrier medium of claim 17, wherein the program instructions are further executable to implement:
re-executing the versions of the second process that retrieved no work item.

25. The carrier medium of claim 17, wherein the carrier medium is a memory medium.
